(19) United States
(12) Patent Application Publication
(10) Pub. No.: US 2012/0134762 A1
(43) Pub. Date: May 31, 2012

(54) MOVING BEAM TYPE MACHINE TOOL

(75) Inventors: Jen-Ji Wang, Taichung City (TW); En-Sheng Chang, Taichung City (TW); Chih-Ming Chen, Taichung City (TW)

(73) Assignee: Industrial Technology Research Institute, Hsinchu (TW)

(21) Appl. No.: 13/044,910

(22) Filed: Mar. 10, 2011

(30) Foreign Application Priority Data
Nov. 29, 2010 (TW) 099141203

(51) Int. Cl. B23C 1/06; B23C 1/14

(52) U.S. Cl. 409/166

(57) ABSTRACT

A moving beam type machine tool is disclosed, having a dynamic phase balancing weight set and a spindle saddle. The spindle saddle has at least one X-axis location feedback device. When the spindle saddle along the X-axis traverse, the at least one X-axis location feedback device is able to locate the spindle saddle and inform a controlling unit. The controlling unit changes the output pressure of the dynamic phase balancing weight set depending on the location of the spindle saddle, so that a crossbeam is able to maintain in a balancing state. The moving beam type machine tool is able to increase accurate, sensitivity of pressure response, withstanding weight and balancing state.

### TECHNICAL FIELD

The present disclosure relates to a moving-beam type machine tool. And more particularly, to a machine tool capable of adjusting the output pressure resulting form a dynamic phase balancing weight set depending on the location of a spindle saddle for enabling a crossbeam to maintain in a balancing state in view of increasing the accuracy, sensitivity of pressure response, weight-bearing capacity and balance control of the machine tool.

### TECHNICAL BACKGROUND

Conventionally, a gantry-type machine center is formed as a machine table having two columns, that are disposed respectively at the two sides thereof, and a crossbeam, that is being mounted between the two columns while enabling the two to move in the longitudinal direction of the columns. Moreover, there is a spindle saddle that is mounted on the crossbeam for enabling the same to move left and right on the crossbeam, whereas the spindle saddle is further configured with a spindle head that is able to rotate relative to the spindle saddle. In addition, the machine table is configured with a workbench at the top thereof that is capable of moving back and forth relative to the machine table.

Operationally, a workpiece is placed on the workbench so as to be moved along with the workbench to a position below the crossbeam, and then the crossbeam capable of moving vertically relative to the workpiece is driven to move toward the workpiece while enabling the spindle saddle mounted thereon to move transversely toward the workpiece and the spindle head to rotate for processing the workpiece.

However, those conventional gantry-type machine centers are disadvantageous in that: since the spindle saddle and the spindle head are both being built with conceivable weights, i.e. they can be pretty heavy, the transverse movement of the spindle saddle on the crossbeam can easily cause the balance of the crossbeam to become unstable and thus adversely affect the processing quality.

For overcoming the aforesaid shortcoming, there are already many improvements over being made, such as a gantry-type machine center with pneumatic counterweight System, a gantry-type machine center with multi-stage ball screw arrangement, and a gantry-type machine center with an arrangement of multiple guide rails, as those disclosed in U.S. Pat. No. 6,161,995, WO2008050024, U.S. Pat. Pub. No. 20040090126, U.S. Pat. No. 7,384,224 and U.S. Pat. Pub. No. 20080096746. However, the aforesaid means or structure of improvement may still have one or all the following shortcomings, that is, it is not sensitive to pressure adjustment, and/or its weight-bearing capacity is limited. Not to mention that the driving means using ball screw rods may cause poor processing accuracy.

Therefore, the gantry-type machine centers that are currently available still have the following shortcomings, that is, poor processing accuracy, poor sensitivity of pressure response, limited weight-bearing capacity and poor balance control, so that it is in need of an improved gantry-type machine center for overcoming the aforesaid shortcomings.

### TECHNICAL SUMMARY

The object of the present disclosure is to a moving beam type machine tool that is capable of adjusting the output pressure resulting form a dynamic phase balancing weight set depending on the detection of a location feedback device relating to the location of a spindle saddle, and thereby, increasing the accuracy, sensitivity of pressure response, weight-bearing capacity and balance control of the machine tool.

To achieve the above object, the present disclosure provides a moving beam type machine tool, comprising: a machine table, having an X-axis direction, a Y-axis direction and a Z-axis direction defined thereat according to a Cartesian coordinate system while being configured with a Y-axis direction limiter at one end thereof; a column, disposed perpendicular to the X-axis direction at an end of the machine table while being configured with two Z-axis direction limiters respectively at two opposite ends relating to a side of the column; a crossbeam, having two X-axis direction limiters arranged at two opposite ends thereof, and moveably mounted on the column while being orientated parallel with the X-axis direction, and being enabling to move in a reciprocating manner following the Z-axis direction; a spindle saddle, movably mounted on the crossbeam and capable of moving in a reciprocating manner following the X-axis direction; and a spindle head, rotatabley coupled to the spindle saddle; a dynamic phase balancing weight set, disposed at two opposite ends of the crossbeam; wherein, in a condition that when the spindle saddle is moved approaching to one end of the crossbeam following the X-axis direction, the output pressure resulting from the dynamic phase balancing weight set that is exerted on that end is increased, and vice versa, and thereby, the balance of the crossbeam is maintained.

In an exemplary embodiment, the dynamic phase balancing weight set has two hydraulic cylinders, being disposed respectively at two ends of the crossbeam while being configured to operate in a manner that the pressure of one hydraulic cylinder that is approached by the spindle saddle is increased while enabling the pressure of another hydraulic cylinder to decrease.

In an exemplary embodiment, the moving beam type machine tool further comprises: a control unit, electrically connected to the dynamic phase balancing weight set.

In an exemplary embodiment, at least one side of the spindle saddle is configured with an X-axis location feedback device, while enabling each of the two sides of the spindle saddle to be configured respectively with an X-axis direction driving device; and each X-axis direction driving device is further configured with at least one X-axis linear motor at its corresponding side of the spindle saddle for driving the spindle saddle to move in the X-axis direction, and each X-axis linear motor as well as the X-axis location feedback device are electrically connected to the control unit in a manner that the control unit is capable of controlling the movement of the spindle saddle through the X-axis linear motors, and also the control unit is capable of changing the output pressure of the hydraulic cylinders depending on the detection of the X-axis location feedback device relating to the location of the spindle saddle.

In an exemplary embodiment, each X-axis direction driving device is further configured with an X-axis rail and at least one X-axis sliding block, in a manner that the X-axis rail is mounted on the crossbeam parallel with the X-axis direction while each X-axis sliding block is slidably arranged at the X-axis rail at a side of the spindle saddle so as to be use for guiding the spindle saddle to perform the reciprocatingly on the X-axis rail.

In an exemplary embodiment, at least one end of the crossbeam is configured with a Z-axis location feedback device while enabling each the two ends of the crossbeam to be configured respectively with a Z-axis direction driving device; and each Z-axis direction driving device is further configured with at least one Z-axis linear motor, each be mounted to its corresponding end of the crossbeam for driving the crossbeam to move reciprocatingly in the Z-axis direction, and each Z-axis linear motor as well as the Z-axis location feedback device are electrically connected to the control unit in a manner that the control unit is capable of locating the position of the crossbeam depending on the detection of the Z-axis location feedback device, and also is capable of controlling the movement of the crossbeam through the Z-axis linear motors.

In an exemplary embodiment, each Z-axis direction driving device is further configured with a Z-axis rail and at least one Z-axis sliding block, in a manner that the Z-axis rail is mounted on the column parallel with the Z-axis direction while each Z-axis sliding block is slidably arranged at the Z-axis rail and simultaneously coupled to the corresponding end of the crossbeam so as to enable the crossbeam to be guided to move reciprocatingly along the Z-axis rail.

In an exemplary embodiment, the moving beam type machine tool further comprises: a rotary workbench, being rotatabley mounted on the machine table while enabling the same to move reciprocatingly in the Y-axis direction; and the rotary workbench is further configured with a rotary element and a movement element in a manner that the rotary element is rotatabley mounted on the movement element, while the movement element is movably mounted on the machine table in a manner that it is enabled to move reciprocatingly in the Y-axis direction; and at least one side of the movement element is configured with an Y-axis location feedback device, while enabling each the two sides at the bottom of the movement element to be configured respectively with an Y-axis direction driving device; and each Y-axis direction driving device is further configured with at least one Y-axis linear motor, each be mounted to its corresponding side of the movement element for driving the movement element to move in the Y-axis direction, and each Y-axis linear motor as well as the Y-axis location feedback device are electrically connected to the control unit in a manner that the control unit is capable of locating the position of the rotary workbench depending on the detection of the Y-axis location feedback device, and also is capable of controlling the movement of the movement element through the Y-axis linear motors.

In an exemplary embodiment, each Y-axis direction driving device is further configured with a Y-axis rail and at least one Y-axis sliding block, in a manner that the Y-axis rail is mounted on the machine table parallel with the Y-axis direction while each Y-axis sliding block is slidably arranged at the Y-axis rail and simultaneously coupled to one end of the bottom of the movement element so as to enable the movement element to be guided to move reciprocatingly along the Y-axis rail.

In an exemplary embodiment, each of the Y-axis location feedback device, the Z-axis location feedback device and the X-axis location feedback device is an optical scale.

To sum up, the control unit is designed to change the output pressure of the dynamic phase balancing weight set depending on depending on the detection of the X-axis location feedback device relating to the location of the spindle saddle in the X-axis direction in a manner that the pressure of one hydraulic cylinder that is approached by the spindle saddle is increased while enabling the pressure of another hydraulic cylinder to decrease, and thereby, the balance of the crossbeam is maintained. Accordingly, the output pressure resulting from the dynamic phase balancing weight set can be adjusted dynamically for enabling the balance of the crossbeam to be maintained stably while enabling the accuracy, sensitivity of pressure response, weight-bearing capacity and balance control of the machine tool to be increased.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a three-dimensional view of a moving beam type machine tool according to the present disclosure.

FIG. 2 is a side view of a moving beam type machine tool according to the present disclosure.

FIG. 3 is a sectional top view of a moving beam type machine tool according to the present disclosure.

FIG. 4 is a section side view of a moving beam type machine tool according to the present disclosure.

FIG. 5 and FIG. 6 are schematic diagrams showing a moving beam type machine tool in operation according to the present disclosure.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

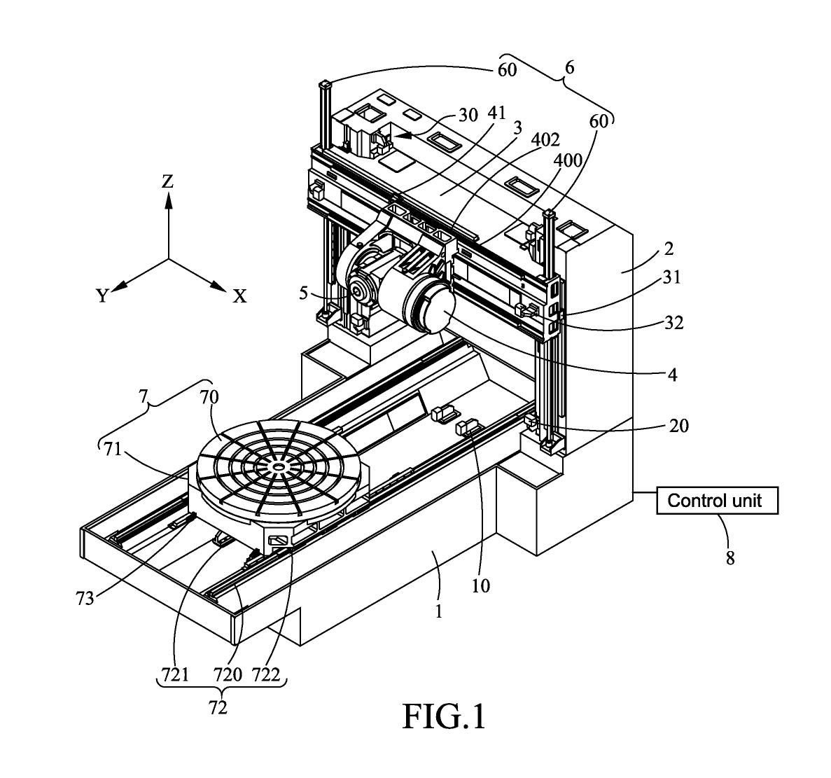

Please refer to FIG. 1, which is a three-dimensional view of a moving beam type machine tool according to the present disclosure. As shown in FIG. 1, the moving beam type machine tool comprises: a machine table 1, a column 2, a crossbeam 3, a spindle saddle 4, a spindle head 5, a dynamic phase balancing weight set 6, a rotary workbench 7 and a control unit 8.

The machine table has an X-axis direction, a Y-axis direction and a Z-axis direction defined thereat according to a Cartesian coordinate system, and is configured with at least one Y-axis direction limiter 10 at one end thereof.

The column 2 is disposed perpendicular to the X-axis direction at an end of the machine table 1, and on at least one side of the column 2, there are two Z-axis direction limiters 20 being configured respectively at the two opposite ends of the referring side.

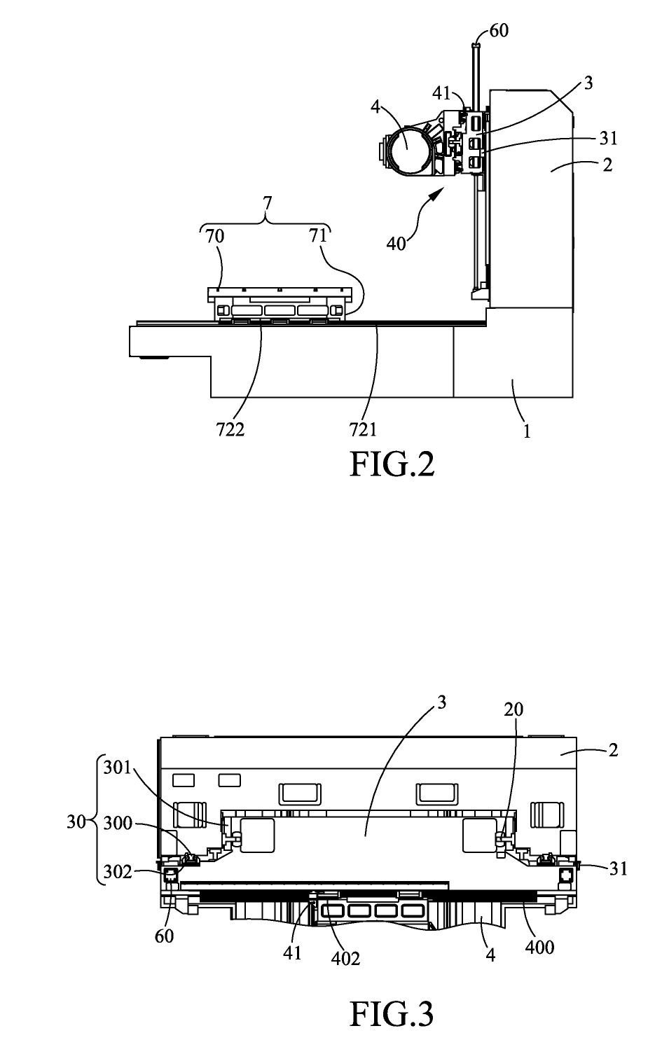

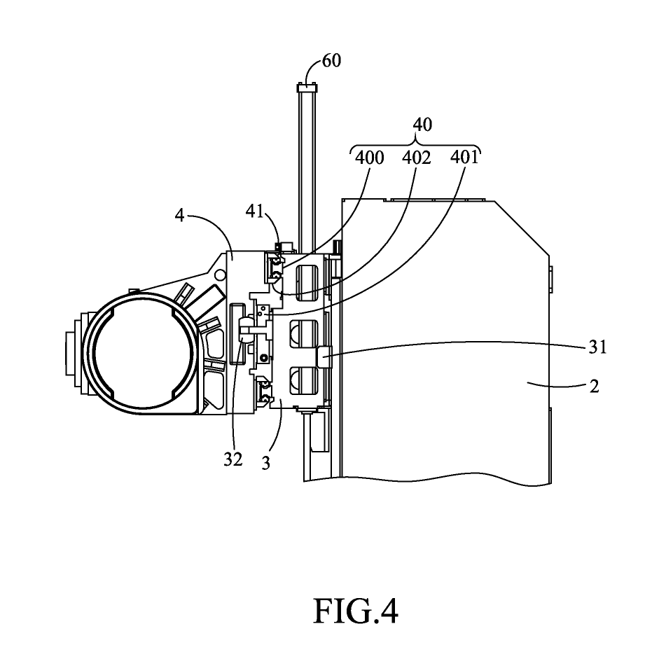

The crossbeam 3 is moveably mounted on the column 2 while being orientated parallel with the X-axis direction. Moreover, as shown in FIG. 2 and FIG. 3, at least one end of the crossbeam 3 is configured with a Z-axis location feedback device 31 while enabling each the two ends of the crossbeam 3 to be configured respectively with a Z-axis direction driving device 30; and each Z-axis direction driving device 30 is further configured with a Z-axis rail 300, at least one Z-axis linear motor 301 and at least one Z-axis sliding block 302 in a manner that the Z-axis rail 300 is mounted on the column 2 while being orientated parallel with the Z-axis direction, while each Z-axis sliding block 302 is slidably arranged at the Z-axis rail 300 and simultaneously coupled to the corresponding end of the crossbeam 3 so as to enable the crossbeam 3 to be guided to move reciprocatingly along the Z-axis rail 300. In addition, there are two X-axis direction limiters 32 being arranged respectively at the two opposite ends of the crossbeam 3.

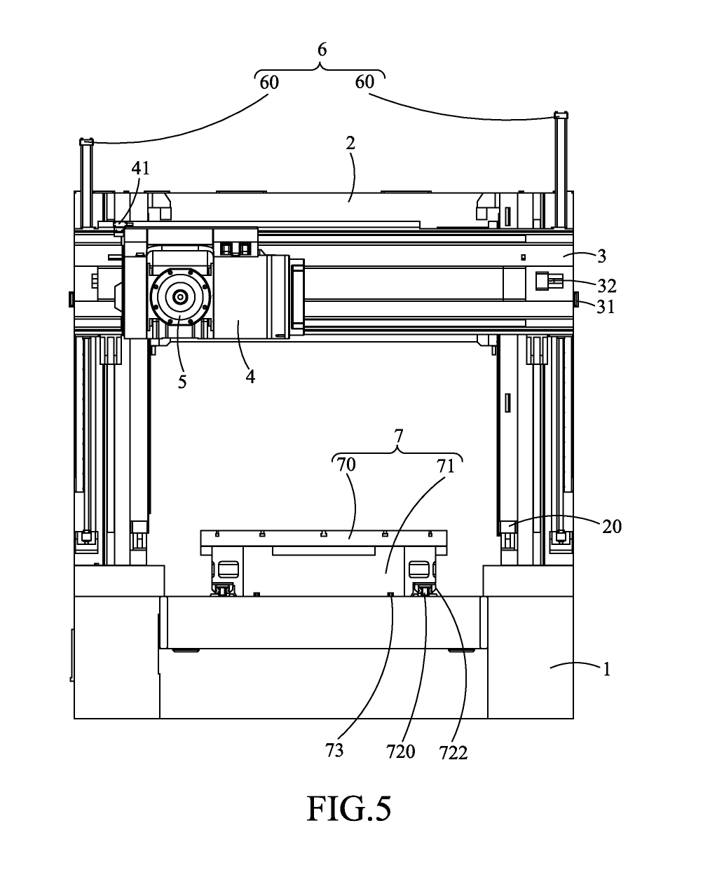

The spindle saddle 4 is movably mounted on the crossbeam 3 while being enabled to move in a reciprocating manner following the X-axis direction. As shown in FIG. 4, at least one side of the spindle saddle 4 is configured with an X-axis location feedback device 41, and there are two X-axis direction driving devices 40 being arranged respectively at the two sides of the spindle saddle 4. Moreover, each X-axis direction driving device 40 is further configured with a X-axis rail 400, at least one X-axis linear motor 401 and at least one X-axis sliding block 402 in a manner that the X-axis rail 400 is mounted on the crossbeam 3 while being orientated parallel with the X-axis direction, and each X-axis sliding block 402 is slidably arranged at the X-axis rail 400 at a side of the spindle saddle 4 so as to be use for guiding the spindle saddle 4 to perform the reciprocatingly on the X-axis rail 400, and each X-axis linear motor 401 is disposed at its corresponding side of the spindle saddle 4 for driving the spindle saddle to move in the X-axis direction.

The spindle head 5 is rotatabley coupled to the spindle saddle 4, which is provided for cutting tools to mount thereat or for holding a workpiece to be processed.

The dynamic phase balancing weight set 6 has two hydraulic cylinders 60, which are being disposed respectively at two ends of the crossbeam while being configured to operate in a manner that the loads of the two hydraulic cylinders 60 are enabled to change according to the distance variation between the spindle saddle 4 and the two hydraulic cylinders 60 in the X-axis direction, that is, the pressure of one hydraulic cylinder 60 that is approached by the spindle saddle is increased while enabling the pressure of another hydraulic cylinder 60 to decrease.

The rotary workbench 7, being rotatabley mounted on one end of the machine table 1, is further configured with a rotary element 70 and a movement element 71 in a manner that the rotary element 70 is rotatabley mounted on the top of the movement element 71, while the movement element 71 is movably mounted on the top of the machine table 1 in a manner that it is enabled to move reciprocatingly in the Y-axis direction. Moreover, at least one side of the movement element 71 is configured with an Y-axis location feedback device 73, while enabling each the two sides at the bottom of the movement element 71 to be configured respectively with an Y-axis direction driving device 72; and each Y-axis direction driving device 72 is further configured with a Y-axis rail 720, at least one Y-axis linear motor 721 and at least one Y-axis sliding block 722 in a manner that the Y-axis rail 720 is mounted on the top of the machine table 1 while being orientated parallel with the Y-axis direction, and each Y-axis sliding block 722 is slidably arranged at the Y-axis rail 720 and simultaneously coupled to one end of the bottom of the movement element 71 so as to enable the movement element 71 to be guided to move reciprocatingly in the Y-axis direction, and each Y-axis linear motor 721 is mounted to its corresponding side of the movement element 71 at the bottom thereof for driving the movement element 71 to move reciprocatingly in the Y-axis direction.

The control unit 8 is electrically connected to each Y-axis linear motor 721, the Y-axis location feedback device 73, the dynamic phase balancing weight set 6, each X-axis linear motor 401, the X-axis location feedback device 41, each X-axis linear motor 301, the X-axis location feedback device 31 and the spindle head 5.

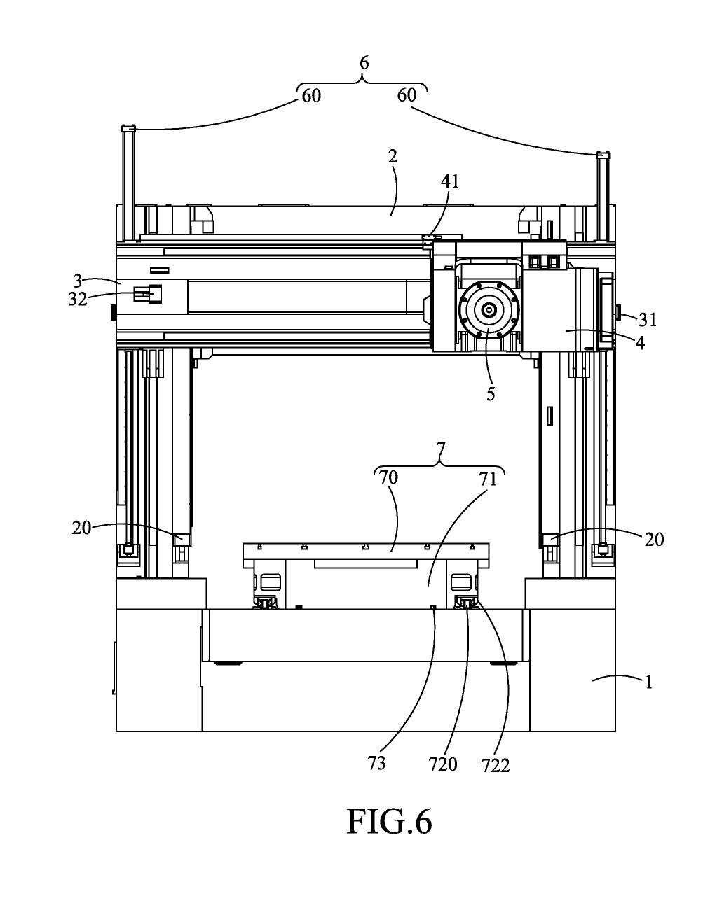

Please refer to FIG. 5 and FIG. 6, which are schematic diagrams showing a moving beam type machine tool in operation according to the present disclosure. As shown in FIG. 5 and FIG. 6, a workpiece that is to be processed by the machine tool is placed on the top of the rotary element 70, and then the Y-axis linear motor 721 is activated for driving the movement element 71 to move on the Y-axis rail 720 in a reciprocating manner so as to move the workpiece toward the column 2, and thereafter, the Z-axis location feedback device 31 is enabled to detect the location of the rotary workbench 7 in the Z-axis direction and then informs the detected Z-direction location to the control unit 8. Thereby, the control unit 8 will made an evaluation to determine whether to direct the Y-axis linear motor 721 to stop the rotary workbench 7 from moving any further, or to direct the Y-axis linear motor 721 to move the rotary workbench 7 further.

At the same time, the rotary element 70 is directed to rotate for adjusting the orientation of the workpiece and thus placing the same to an optimal machining angle for processing.

The Z-axis linear motor 301 is used for driving the crossbeam 3 to move on the Z-axis rail 300 in a reciprocating manner; and the Z-axis location feedback device 31 is also being enabled to detect the location of the crossbeam 3 in the Z-axis direction and then informs the detected Z-direction location of the crossbeam 3 to the control unit 8. Thereby, the control unit 8 will made an evaluation to determine whether to direct the Z-axis linear motor 301 to stop the crossbeam 3 from moving any further, or to direct the Z-axis linear motor 301 to move the crossbeam 3 further.

The X-axis linear motor 401 is used for driving the spindle saddle 4 to move on the X-axis rail 400 in a reciprocating manner; and the X-axis location feedback device 41 is being enabled to detect the location of the spindle saddle 4 in the X-axis direction and then informs the detected X-direction location of the spindle saddle 4 to the control unit 8. Thereby, the control unit 8 will made an evaluation to determine whether to direct the X-axis linear motor 401 to stop the spindle saddle 4 from moving any further, or to direct the X-axis linear motor 401 to move the spindle saddle 4 further.

As soon as the signal from the X-axis location feedback device 41 is received by the control unit 8, the control unit 8 is informed with the information relating to the location of the spindle saddle 4 in the X-axis direction, and accordingly, the control unit 8 is enabled to issue a signal to the dynamic phase balancing weight set 6 for enabling the same to operate in a manner that the pressure of one hydraulic cylinder 60 that is approached by the spindle saddle 4 is increased while enabling the pressure of another hydraulic cylinder 60 to decrease, so that the balance of the crossbeam 3 can be maintained.

The spindle head 5 is either being provided for cutting tools to mount thereat, or for holding a workpiece to be processed by a cutting tool.

It is noted that the arrangement of the Y-axis direction limiter 10 is used for blocking the movement of the rotary workbench 7 for preventing the same from moving out of the processing range in the Y-axis direction, by that the movement of the rotary workbench 7 in the Y-axis direction is restricted within a specific range. Similarly, the arrangement of the Z-axis direction limiter 20 is used for blocking the movement of the crossbeam 3 for preventing the same from moving out of the processing range in the Z-axis direction, by that the movement of the crossbeam 3 in the X-axis direction is restricted within a specific range; and the arrangement of the X-axis direction limiter 32 is used for blocking the movement of the spindle saddle 4 for preventing the same from moving out of the processing range in the X-axis direction, by that the movement of the spindle saddle 4 in the X-axis direction is restricted within a specific range.

In addition, each of the X-axis location feedback device 41, the Y-axis location feedback device 73 and the X-axis location feedback device 31 can be an optical scale, by that the location of the spindle saddle 4 in the X-axis direction, the location of the rotary workbench 7 in the Y-axis direction and the location of the crossbeam 3 in the Y-axis direction can be measured and then to be informed to the control unit 8 for enhancing the control accuracy of the same.

Moreover, the control unit is able to change the output pressure of the dynamic phase balancing weight set 6 depending upon the aforesaid location information, by that the load difference at the two ends of the crossbeam can be overcome for enabling the balance of the crossbeam 3 to be maintained when the spindle saddle 4 is driven to move in a reciprocating manner along the X-axis direction on the crossbeam 3, and thereby, increasing the accuracy, sensitivity of pressure response, weight-bearing capacity and balance control of the machine tool.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A moving beam type machine tool, comprising:
a machine table, having an X-axis direction, a Y-axis direction and a Z-axis direction defined thereat according to a Cartesian coordinate system;
a column, disposed perpendicular to the X-axis direction at an end of the machine table;
a crossbeam, moveably mounted on the column in a direction parallel with the X-axis direction while being enabling to move in a reciprocating manner following the Z-axis direction;
a spindle saddle, movably mounted on the crossbeam and capable of moving in a reciprocating manner following the X-axis direction;
a spindle head, rotatabley coupled to the spindle saddle; and
a dynamic phase balancing weight set, disposed at two opposite ends of the crossbeam;
wherein, in a condition that when the spindle saddle is moved in the X-axis direction approaching to the dynamic phase balancing weight set, the output pressure resulting from the dynamic phase balancing weight set is increased, and when the spindle saddle is moved in the X-axis direction away from the dynamic phase balancing weight set, the output pressure resulting from the dynamic phase balancing weight set is decreased, and thereby, the balance of the crossbeam is maintained.

2. The moving beam type machine tool of claim 1, wherein the dynamic phase balancing weight set has two hydraulic cylinders, being disposed respectively at two ends of the crossbeam while being configured to operate in a manner that the pressure of one hydraulic cylinder that is approached by the spindle saddle is increased while enabling the pressure of another hydraulic cylinder to decrease.

3. The moving beam type machine tool of claim 2, further comprising: a control unit, electrically connected to the dynamic phase balancing weight set; wherein at least one side of the spindle saddle is configured with an X-axis location feedback device, while enabling each of the two sides of the spindle saddle to be configured respectively with an X-axis direction driving device; and each X-axis direction driving device is further configured with at least one X-axis linear motor at its corresponding side of the spindle saddle for driving the spindle saddle to move in the X-axis direction, and each X-axis linear motor as well as the X-axis location feedback device are electrically connected to the control unit in a manner that the control unit is capable of controlling the movement of the spindle saddle through the X-axis linear motors, and also the control unit is capable of changing the output pressure of the hydraulic cylinders depending on the detection of the X-axis location feedback device relating to the location of the spindle saddle.

4. The moving beam type machine tool of claim 3, wherein each X-axis direction driving device is further configured with an X-axis rail and at least one X-axis sliding block, in a manner that the X-axis rail is mounted on the crossbeam parallel with the X-axis direction while each X-axis sliding block is slidably arranged at the X-axis rail at a side of the spindle saddle so as to be use for guiding the spindle saddle to perform the reciprocatingly on the X-axis rail.

5. The moving beam type machine tool of claim 4, wherein at least one end of the crossbeam is configured with a Z-axis location feedback device while enabling each the two ends of the crossbeam to be configured respectively with a Z-axis direction driving device; and each Z-axis direction driving device is further configured with at least one Z-axis linear motor, each be mounted to its corresponding end of the crossbeam for driving the crossbeam to move reciprocatingly in the Z-axis direction, and each Z-axis linear motor as well as the Z-axis location feedback device are electrically connected to the control unit in a manner that the control unit is capable of locating the position of the crossbeam depending on the detection of the Z-axis location feedback device, and also is capable of controlling the movement of the crossbeam through the Z-axis linear motors.

6. The moving beam type machine tool of claim 5, wherein each Z-axis direction driving device is further configured with a Z-axis rail and at least one Z-axis sliding block, in a manner that the Z-axis rail is mounted on the column parallel with the Z-axis direction while each Z-axis sliding block is slidably arranged at the Z-axis rail and simultaneously coupled to the corresponding end of the crossbeam so as to enable the crossbeam to be guided to move reciprocatingly along the Z-axis rail.

7. The moving beam type machine tool of claim 6, further comprising: a rotary workbench, being rotatabley mounted on the machine table while enabling the same to move reciprocatingly in the Y-axis direction.

8. The moving beam type machine tool of claim 7, wherein the rotary workbench is further configured with a rotary element and a movement element in a manner that the rotary element is rotatabley mounted on the movement element, while the movement element is movably mounted on the machine table in a manner that it is enabled to move reciprocatingly in the Y-axis direction.

9. The moving beam type machine tool of claim 8, wherein at least one side of the movement element is configured with an Y-axis location feedback device, while enabling each the two sides at the bottom of the movement element to be configured respectively with an Y-axis direction driving device; and each Y-axis direction driving device is further configured with at least one Y-axis linear motor, each be mounted to its corresponding side of the movement element for driving the movement element to move in the Y-axis direction, and each Y-axis linear motor as well as the Y-axis location feedback device are electrically connected to the control unit in a manner that the control unit is capable of locating the position of the rotary workbench depending on the detection of the Y-axis location feedback device, and also is capable of controlling the movement of the movement element through the Y-axis linear motors.

10. The moving beam type machine tool of claim 9, wherein each Y-axis direction driving device is further configured with a Y-axis rail and at least one Y-axis sliding block, in a manner that the Y-axis rail is mounted on the machine table parallel with the Y-axis direction while each Y-axis sliding block is slidably arranged at the Y-axis rail and simultaneously coupled to one end of the bottom of the movement element so as to enable the movement element to be guided to move reciprocatingly along the Y-axis rail.

11. The moving beam type machine tool of claim 10, wherein each of the Y-axis location feedback device, the Z-axis location feedback device and the X-axis location feedback device is an optical scale.

12. The moving beam type machine tool of claim 11, wherein at least one end of the machine table is configured with at least one Y-axis direction limiter; on at least one side of the column, there are two Z-axis direction limiters being respectively arranged at two opposite ends of the referring side of the column; there are two X-axis direction limiters being arranged respectively at two opposite ends of the crossbeam.
